(19) United States
(12) Patent Application Publication
(10) Pub. No.: US 2007/0299759 A1
(43) Pub. Date: Dec. 27, 2007

(54) HYBRID MORTGAGE-BACKED INVESTMENT VEHICLES AND A METHOD AND SYSTEM FOR HYBRID MORTGAGE-BACKED INVESTMENT VEHICLES

(76) Inventor: Keith Kelly, Arlington, VA (US)

Correspondence Address: ROTHWELL, FIGG, ERNST & MANBECK, P.C., 1425 K STREET, N.W., SUITE 800, WASHINGTON, DC, 20005, US

(21) Appl. No.: 11/765,125

(22) Filed: Jun. 19, 2007

Related U.S. Application Data
(60) Provisional application No. 60/814,584, filed on Jun. 19, 2006.

(51) Int. Cl. G06Q 40/00

(52) U.S. Cl. 705/36 R

(57) ABSTRACT

A hybrid mortgage-backed investment vehicle in which the pool of mortgages which back the investment vehicle is made up of selected traditional and modifiable mortgages. This invention allows for increased customization over traditional mortgage-backed securities which may be backed by pools of either traditional or modifiable mortgages, but not both. This flexibility may be used to better tailor mortgage-backed securities to meet investor goals, and as such may lead to more successful securities. Specifically, the use of modifiable mortgages in combination with traditional mortgages may lead to increased retention of mortgages in mortgage pool. This is achieved through the decreased prepayment of modifiable mortgages. Additionally, the current invention includes as method and system for practicing hybrid mortgage-backed investment vehicles.

### BACKGROUND OF THE INVENTION

1. Field of the Invention

The present invention relates to hybrid mortgage-backed investment vehicles and systems and methods for structuring hybrid mortgage-backed investment vehicles and, more specifically, towards structuring mortgage pools for mortgage-backed securities which are comprised of both traditional and modifiable mortgages.

2. Description of the Related Art

The most common mortgage-backed investment vehicle is a mortgage-backed security. A mortgage-backed security is a type of asset backed security in which the backing assets are mortgages. Beginning in the 1970s, mortgage-backed securities have gained popularity and momentum as investments among both individual and institutional investors. Most mortgage-backed securities are issued by one of three government-sponsored agencies or enterprises known as Ginnie Mae (Government National Mortgage Association), Freddie Mac (Federal home Loan Mortgage Corporation), and Fannie Mae (Federal National Mortgage Association).

In order to form the most basic pass-through mortgage-backed securities, a number of mortgages are grouped or “pooled” together in order to diversify the mortgage portfolio. A portion of this mortgage pool is then sold to investors, who are then compensated from the principle and interest gathered collectively on the pooled mortgages.

This basic principle has been expanded in order to fit individual investors' needs and desires in a number of ways, such as: goal oriented diversification; collateralized mortgage obligations; and stripped mortgage-backed securities. The diversification achieved through pooling mortgages can be tailored to achieve a variety of goals, such as the minimization of risk or the maximization of gain. Depending on the desired goal of the investor, the composition of the pool is altered to exploit properties of the mortgages. For example, mortgages with high interest rates have high prepayment risk during periods of interest rate reduction; however those same mortgages present the opportunity to have high returns on investment. Thus, for example, a mortgage-backed security which is focused on maximizing return on investment at while accepting the risk of high prepayment might contain a majority of mortgages which have high interest rates.

Different forms of mortgage-backed securities are also used to meet investor demand. These different forms include collateralized mortgage obligation and stripped mortgage-backed security. A collateralized mortgage obligation is a more complex version of the basic pass-through mortgage-backed security, in which the backing mortgages are divided into “tranches” or “classes” by some quality, for example term or interest rate. These distinct tranches are then sold as separate securities at different price points depending on the properties of each individual tranche rather than the properties of the pool as a whole. A stripped mortgage-backed security divides the mortgage payment into principal and interest, and uses each individually to back separate securities, i.e. interest-only SMBS and principal-only SMBS. Generally, the above mentioned ways of designing mortgage-backed securities which fit investor needs, relate directly to the risk involved with the prepayment of mortgages in the pool.

Prepayment occurs anytime the mortgagee pays more than the required mortgage payment. A common manner in which prepayment occurs is through the refinancing of a mortgage. Mortgage refinancing refers to applying for a secured loan intended to replace an existing loan secured by the same real property. There are many reasons for refinancing a mortgage including: lowering the interest rate on the mortgage; to pay off other debts; to lengthen the mortgage repayment period; to reduce risk associated with the current mortgage; or to liquidate some or all of the equity that has accumulated in the real property.

As prepayments occur, the amount of principal retained in the mortgage-backed security declines faster than what otherwise may be expected, thus shortening the average life of the mortgage-backed security by returning principal prematurely to the security holder. Mortgage-backed securities are often discussed in terms of average life rather than their stated maturity date. The average life is the average time that each principal dollar in the pool is expected to be outstanding, based upon certain assumptions about prepayment speeds.

There is a correlation between the rise and fall of mortgage interest rates and the speed of mortgage loan repayment. Prepayment is generally precipitated by a decline in interest rates. Specifically, as interest rates decline mortgagees are more likely to refinance their current mortgages. A more detailed description of prepayment risk is as follows.

Lending rates of return offered to investors are priced according to several market factors. Rates of return are offered beginning at par and from par move either lower by mortgagees paying discount fees (advanced interest called points) or higher where the investor pays above par pricing (rebates to the mortgagee). Par value is a price equal to the face amount of a security, as distinct from its market value. On a debt security, the par or face value is the amount the investor has been promised to receive from the issuer at maturity.

For example, an interest rate of return offered at par is 8%. An interest rate of 7.75% can be offered to a consumer if they pay an advance fee of 1 point (1% of the loan balance). The investor will receive the 1 point in exchange for providing the mortgagee a lower rate of interest. An interest rate offered at 8.25% would have the investor giving the mortgagee a 1 point rebate (a 1 percent of the loan balance credit) in exchange for the investor receiving a higher rate of return.

The problem arises when investors pay 1%, 2%, 3% even 4% rebates in exchange for higher rates of return expecting that the mortgagee who is paying the loan will keep that loan long enough for the investor to recoup the rebates spent. This problem, as mentioned above, is precipitated when interest rates decline and consumers refinance their loan to receive a lower interest rate. When the consumer refinances their loan the investor is repaid their invested money. If the investor wants to reinvest their money at above par pricing and get a higher rate of return they need to provide another rebate to the mortgagee. Do to education by commission earning loan officers mortgagees often use above par rebates to pay for their closing costs on the refinance process. When the mortgagee uses par plus pricing (rebates from the investor) to pay their closing costs even if interest rates drop by as little as 0.25% they are prone to refinance again since it did not cost them any closing costs. When investors are repaid it diminishes their rate of return due to the rebates they paid.

Accordingly, there is a need for a mortgage-backed investment vehicle that overcomes the problems identified above and is created to pay a higher rate of return to investors.

### SUMMARY OF THE INVENTION

It is an object of the present invention to overcome the problems discussed above by providing a mortgage-backed investment vehicle in which the pool of mortgages is comprised of both traditional and modifiable mortgages.

It is a further object of the present invention to provide a method for establishing what mortgages will comprise a pool of loans which back the hybrid mortgage-backed investment vehicle.

It is a further object of the present invention to provide a computer system which assists in the creation of a hybrid-mortgage backed investment vehicle.

The present invention may be used by investment professionals in establishing hybrid mortgage-backed investment vehicles. In accordance with the present invention a hybrid mortgage backed investment vehicle is backed with a set of mortgages, which this application will refer to as a pool of mortgages. In a hybrid mortgage-backed investment vehicle this pool of mortgages contains both traditional and modifiable mortgages. These traditional and modifiable mortgages have other properties, e.g. principal and interest rate, which affect the properties of the pool of mortgages as a whole. Thus, by selectively including both traditional and modifiable mortgages in the pool of mortgages, an investment vehicle may be crafted in order to achieve a desired investment strategy. For example, gathering both traditional and modifiable mortgages into a pool of mortgages may allow the originator of the investment vehicle to hedge against high mortgage prepayment speeds when interest rates decline.

### BRIEF DESCRIPTION OF THE PREFERRED EMBODIMENTS

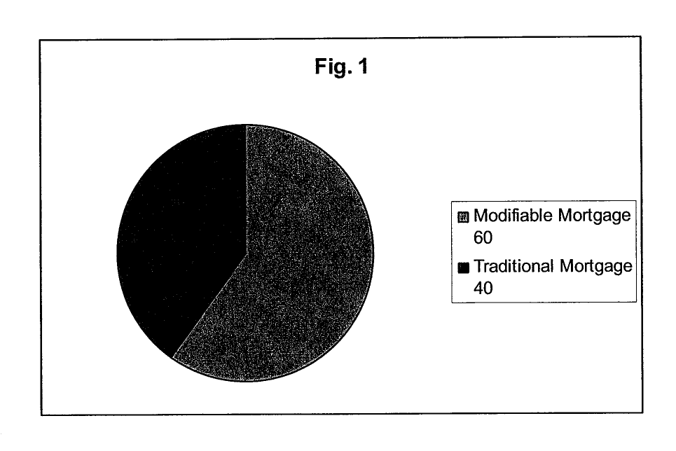

FIG. 1 is a pie chart representing one example of proportions of traditional and modifiable mortgages contained in a pool of mortgages in accordance with one example of the present invention.

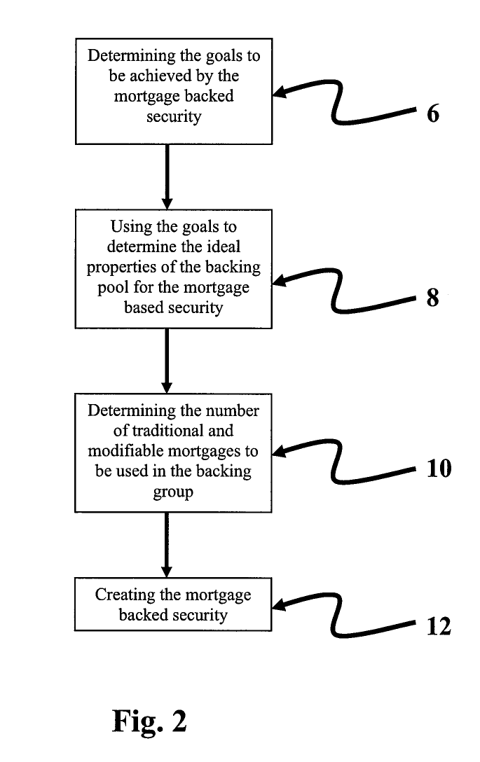

FIG. 2 is a flowchart describing steps preformed in the formation of a mortgage pool associated with a mortgage-backed security in accordance with one embodiment of the present invention.

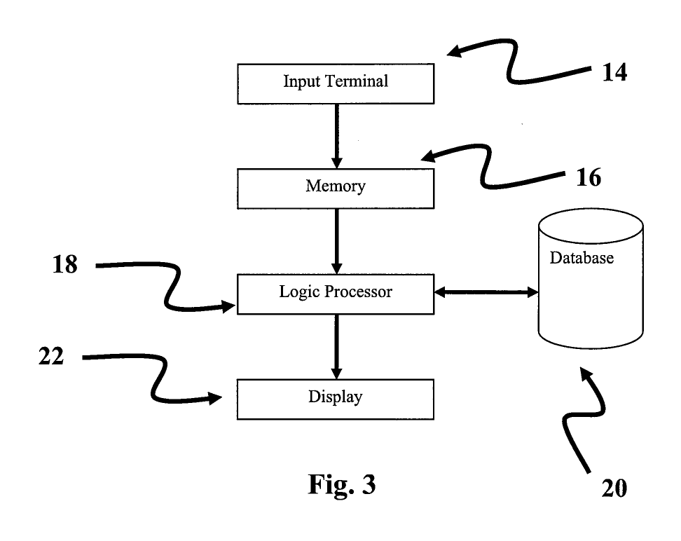

FIG. 3 is a schematic of a computer system for creating a hybrid mortgage-backed investment vehicle in accordance with one embodiment of the present invention.

### DETAILED DESCRIPTION OF THE PREFERRED EMBODIMENTS

In accordance with the present invention a hybrid mortgage backed investment vehicle is provided which is backed by a pool of mortgages containing both traditional and modifiable mortgages. A modifiable mortgage as described herein is a mortgage that can have its interest rate lowered without refinancing. See, e.g., U.S. Pat. No. 5,878,404, incorporated herein by reference, which describes a system and method for managing the amortization of a loan which automatically resets the rate of interest stored in memory in response to the debtor's election, yet holds the rate of interest stored in memory fixed in the absence of such an election. A modifiable mortgage is a mortgage device designed to accomplish, among other things, a lower refinance rate by mortgagees in times of decreasing interest rates and, in addition, dramatically increase the retention rates for mortgage servicers and mortgage investors. Thus, modifiable mortgages generally have a lower prepayment rate than traditional mortgages.

These traditional and modifiable mortgages have other properties, e.g. principal and interest rate, which affect the properties of the pool of mortgages as a whole. Thus, by selectively including both traditional and modifiable mortgages in the pool of mortgages, an investment vehicle may be crafted in order to achieve a desired investment strategy. For example, gathering both traditional and modifiable mortgages into a pool of mortgages may allow the originator of the investment vehicle to hedge against high mortgage prepayment speeds when interest rates decline.

Referring to FIG. 1, there is shown a pie chart representing one example of proportions of traditional and modifiable mortgages contained in a pool of mortgages. In this example, the pool of mortgage is made up of 60% modifiable mortgages and 40% traditional mortgages. The exact composition of the pool of mortgages may vary depending on the goals of the mortgage-backed investment vehicle. Further, the properties of the traditional and modifiable mortgages making up the pool of loans may vary depending on the goals of the mortgage-backed investment vehicle. These properties may include, for example, the term of the mortgage, the interest rate of the mortgage; the risk of prepayment on the mortgage; or the risk that the mortgagee will default on the mortgage.

In one possible embodiment of the current invention, the composition of a pool of mortgages may contain modifiable mortgages which were executed at above par pricing and traditional mortgages executed at par or below par pricing. The use of above par modifiable mortgages lowers the prepayment risk investors incur when using above par traditional mortgages. This is because generally modifiable mortgages have slower prepayment rates than traditional mortgages. The ultimate effect is that the above par modifiable mortgages are prepaid less rapidly and thus remain in the pool of mortgages for longer periods of time. This mitigates the loss investors would incur if they were repaid faster than expected and had to reinvest their money.

For example, a traditional mortgage made to a mortgagee for $200,000 at an interest rate of 8.5% with a 3% rebate would cost the investor $6,000 at the time the mortgage is executed. Assuming the mortgagee uses the $6,000 to pay their closing costs, the mortgagee has incurred no out of pocket expense. This mortgage is then included in a pool of mortgages backing an investment vehicle. If the interest rates decline to 8% and the mortgagee refinances using another 3% rebate to pay the closing costs, the mortgagee has achieved a lower interest rate mortgage for no out of pocket expense.

Because this mortgage has been prepaid in full, the mortgage is no longer in the pool of mortgages. Now, the investor must spend another $6,000 to secure a replacement mortgage which has an above par rate of return. Thus, while the mortgagee did not have any out of pocket expense, the investor will have spent $12,000 in total. However, by practicing the current invention this situation may be avoided.

If the above par mortgage would have been a modifiable mortgage, the mortgagee would not need to refinance in order to achieve a lower interest rate. The modifiable mortgage would provide the opportunity for the mortgagee to call their servicer and choose to have their interest rate dropped without going through a traditional refinance. The modifiable mortgage could also be structured to automatically adjust the mortgage interest rate down in periods of interest rate decline. Because the mortgagee does not need to refinance, the mortgage remains in the pool of mortgages and the investor does not have to secure a replacement mortgage. Therefore, the investor does not have to spend the $6,000 in securing the second mortgage and the mortgagee still gets a lower interest rate. Since the modifiable interest rate takes into consideration the above par pricing to cover a consumer's closing costs the investor will still receive a higher interest rate, i.e. a consumer whose interest rate is 8.5% is offered a refinance at 8% with no closing costs. The 8% with no closing costs has an investor paying a 103 price and receiving an above par rate of return. The modifiable rate offered to the mortgagee in the present invention pool would be offered the same 8% modifiable rate thus providing the investor an above par rate of return without paying the 103 price or $6000 rebate. It is a win-win situation.

Referring to FIG. 2, there is shown a flowchart which describes the simplified steps preformed in the formation of a mortgage pool associated with a mortgage-backed security. In one embodiment of the invention, a mortgage-backed security originator (for example Ginnie Mae, Freddie Mac, or Fannie Mae) determines the goals to be met by the mortgage-backed security, as shown by step 4. These goals may be, for example, the maximization of yield in the short term, the maximization of yield in the long term, the minimization of prepayment risk, or the minimization of mortgagee default risk. Further, several of these goals may be met by the same mortgage-backed security. For example, generally securities which have the opportunity to produce the highest yield carry with them the highest risk.

Once the goals of the mortgage-backed security have been decided upon, they are used to determine the ideal properties of the backing pool of the mortgage backed security, as shown in step 6. These properties may include, for example, the term of the mortgage, the interest rate of the mortgage; the risk of prepayment on the mortgage; or the risk that the mortgagee will default on the mortgage.

After the desired properties of the mortgage have been identified, the number of traditional and modifiable mortgages to be used in the backing group must be determined, as shown in step 8. For example, if the security being established is to have a lower risk of prepayment, the number of modifiable mortgages included would be greater because the risk of refinancing is lower with a modifiable as compared to a traditional mortgage. Once the proper combination of traditional and modifiable mortgages with the ideal properties to be used in the backing pool is established, the mortgage-backed security is created, as shown in step 10.

Referring to FIG. 3, input terminal 14 is used to input into memory 16 information about the desired characteristics of the hybrid mortgage-backed investment vehicle. The logic processor 18 uses the input contained in memory 16 in combination with information contained in the database 20 in order to determine the properties and composition of a pool of mortgages used to back a hybrid mortgage-backed investment vehicle. This determined information is then presented to the user on a display 22.

For example, in a simplified embodiment a software package might be written for a user terminal which allows the user to input desired characteristics of a hybrid mortgage-backed investment vehicle by inputting the amount of risk they are willing to assume (on a scale of 1-100). This number is then stored in random access memory which is accessed by the central processing unit of the computer (“CPU”). The CPU then applies logical rules contained in the software to the user's stored input to determine the properties of traditional and modifiable mortgages to be pooled in order to accomplish the user's desired risk level. The CPU then communicates with a database containing additional information, such as available mortgages to be pooled, in order to find mortgages which match the needed properties. The results of this search are then displayed to the user through a computer monitor.

A mortgage pool behind a mortgage-backed security composed of both traditional and modifiable mortgages would create opportunities to more specifically tailor mortgage-backed securities to investor needs. A pool of loans may be arranged so that traditional mortgages are combined with modifiable mortgages for hedging purposes to protect the pool from high prepayment speeds at times of interest rate decline.

What is claimed is:

1. A hybrid mortgage-backed investment vehicle comprising a pool of mortgages, wherein said pool of mortgages includes at least on traditional mortgage and at least one modifiable mortgage.

2. The hybrid mortgage-backed investment vehicle as claimed in claim 1, wherein said hybrid mortgage-backed investment vehicle is a hybrid mortgage-backed security.

3. The hybrid mortgage-backed investment vehicle as claimed in claim 1, wherein said hybrid mortgage-backed investment vehicle is a hybrid mortgage-backed bond.

4. The hybrid mortgage-backed investment vehicle as claimed in claim 1, wherein said hybrid mortgage-backed investment vehicle is a hybrid mortgage-backed fund.

5. The hybrid mortgage-backed investment vehicle as claimed in claim 1, wherein said pool of mortgages is a collection of mortgages.

6. The hybrid mortgage-backed investment vehicle as claimed in claim 5, wherein said collection of mortgages is comprised of commercial mortgages.

7. The hybrid mortgage-backed investment vehicle as claimed in claim 5, wherein said collection of mortgages is comprised of residential mortgages.

8. The hybrid mortgage-backed investment vehicle as claimed in claim 5, wherein said collection of mortgages is comprised of commercial mortgages and residential mortgages.

9. The hybrid mortgage-backed investment vehicle as claimed in claim 1, wherein said at least one traditional mortgage is a fixed interest rate mortgage.

10. The hybrid mortgage-backed investment vehicle as claimed in claim 1, wherein said at least one traditional mortgage is an adjustable interest rate mortgage.

11. The hybrid mortgage-backed investment vehicle as claimed in claim 1, wherein said at least one modifiable mortgage has the capability for interest rate reduction when the current interest rate is lower than the current modifiable mortgage interest rate.

12. The hybrid mortgage-backed investment vehicle as claimed in claim 1, wherein the said at least one traditional mortgage and said at least on modifiable mortgage have properties associated with mortgages.

13. The hybrid mortgage-backed investment vehicle as claimed in claim 12, wherein said properties associated with mortgages include principal amount; interest rate; term; prepayment risk; and default risk.

14. A method of creating mortgage-backed security comprising the steps of:
determining the goals to be achieved by the mortgage backed security;
determining the ideal properties of the backing pool for the mortgage based security;
determining the number of at least one traditional and at least on modifiable mortgage to be used in the backing pool of said hybrid mortgage-backed security; and
creating said hybrid mortgage-backed security using said backing pool.

15. The method of claim 14, further comprising the step of determining a risk to be associated with said backing pool.

16. The method of claim 15, further comprising the step of choosing the number of traditional mortgages to be included in said backing pool and the number of modifiable mortgages to be included in said backing pool based on the level of risk desired in said hybrid mortgage-backed security.

17. The method of claim 15, further comprising the step of using said risk to determine a ratio of traditional to modifiable mortgages to be used in the single backing pool to obtain the risk.

18. The method of claim 17, further comprising the step of using said ratio of traditional to modifiable mortgages to determine the number of traditional and the number of modifiable mortgages to be included in the single backing pool.

19. A computer system for establishing a pool of mortgages for a hybrid mortgage-backed investment vehicle comprising,
input means for inputting desired properties of said hybrid mortgage-backed security;
logic means for determining the properties of said pool of mortgages, and the composition of said pool of mortgages; and
display means for displaying the ideal composition of said pool of mortgages.
